(19) United States
(12) Patent Application Publication
(10) Pub. No.: US 2023/0003132 A1
(43) Pub. Date: Jan. 5, 2023

(54) FRANGIBLE AIRFOIL

(71) Applicant: General Electric Company, Schenectady, NY (US)

(72) Inventors: Nitesh Jain, Bangalore (IN); Abhijeet Jayshingrao Yadav, Karad (IN); Nicholas Joseph Kray, Mason, OH (US); Ch K Phani Sri Krishna, Kakinada (IN)

(21) Appl. No.: 17/366,525

(22) Filed: Jul. 2, 2021

(51) Int. Cl. F01D 5/28; F01D 5/14

(52) U.S. Cl. CPC F01D 5/282; F01D 5/147; F05D 2220/36; F05D 2300/6033

(57) ABSTRACT

An airfoil including a plurality of composite plies extending from a leading edge to a trailing edge and between a tip and a root. The airfoil further includes a frangible airfoil portion at the tip extending between the leading edge and the trailing edge and extending between the tip and a frangible line along a span including a first plurality of composite plies. The frangible airfoil portion includes a first plurality of composite plies including fibers having a first fiber modulus. The airfoil further includes a residual airfoil portion extending from the frangible line to the root along the span including a second plurality of composite plies. The second plurality of composite plies including one or more plies having a second fiber modulus. The second fiber modulus is greater than the first fiber modulus. Further, the residual airfoil portion meets the frangible airfoil portion at the frangible line.

### FIELD

The present subject matter relates generally to airfoils, such as frangible airfoils for gas turbine engines.

### BACKGROUND

Airfoils used in aircraft engines, such as fan blades of a gas turbine engine, can be susceptible to extreme loading events. For instance, a fan blade might strike a bird that is ingested into the engine, or a blade-out occurrence may arise wherein one of the fan blades is severed from a rotor disk. If the impact is large enough, a fan blade may break apart into one or more shards before traveling downstream through the engine.

Gas turbine engines, such as turbofans, generally include fan cases surrounding a fan assembly including the fan blades. Fan cases generally include frangible structures, such as honeycombs or trench-filler material, configured to mitigate load transfer to and through the fan case. However, this approach is costly and may result in larger, heavier, less efficient fan cases. Still further, this approach may not address issues relating to fan rotor unbalance following deformation or liberation of one or several airfoils such as fan blades.

As such, there is a need for an airfoil that enables a controlled and consistent failure mode of the airfoil that may enable reducing a cost, weight, and load transfer to a surrounding casing.

### BRIEF DESCRIPTION

Aspects and advantages will be set forth in part in the following description, or may be obvious from the description, or may be learned through practice of the disclosure.

In one aspect, the present subject matter is directed to an airfoil defining a span extending in a spanwise direction between a root and a tip; a chordwise direction extending between a leading edge and a trailing edge; a thickness direction extending between a pressure side and a suction side; and a frangible line at a location along the span. The airfoil includes a frangible airfoil portion extending between the leading edge and the trailing edge and extending along the span between the tip and the frangible line. The frangible airfoil portion comprises a first plurality of composite plies, one or more of the first plurality of composite plies having fibers defining a first fiber modulus. The airfoil includes a residual airfoil portion extending along the span from the frangible line to the root. The residual airfoil portion comprising a second plurality of composite plies having fibers defining a second fiber modulus, wherein the second fiber modulus is greater than the first fiber modulus, wherein the residual airfoil portion meets the frangible airfoil portion at the frangible line.

In another aspect, the present subject matter is directed to a gas turbine engine defining a central axis. The gas turbine engine includes an engine shaft extending along the central axis, a compressor attached to the engine shaft and extending radially about the central axis, a combustor positioned downstream of the compressor to receive a compressed fluid therefrom, a turbine mounted on the engine shaft downstream of the combustor to provide a rotational force to the compressor, and a plurality of airfoils operably connected to the engine shaft. Each of the plurality of airfoils defines a span extending in a spanwise direction between a root and a tip, a chordwise direction extending between a leading edge and a trailing edge, and a thickness direction extending between a pressure side and a suction side.

Each includes a frangible airfoil portion extending between the leading edge and the trailing edge and extending between the tip and a frangible line along the span. The frangible airfoil portion includes a first plurality of composite plies having fibers including a first fiber modulus. Each airfoil further includes a residual airfoil portion extending from the frangible line to the root along the span. The residual airfoil portion includes a second plurality of composite plies. The second plurality of composite plies includes fibers having a second fiber modulus. The second fiber modulus is greater than the first fiber modulus. Further, the residual airfoil portion meets the frangible airfoil portion at the frangible line. It should be further understood that the gas turbine engine may further include any of the additional features as described herein.

In another aspect, the present subject matter is directed to a method of forming a frangible airfoil. The frangible airfoil defines a span extending in a spanwise direction between a root and a tip, a chordwise direction extending between a leading edge and a trailing edge, and a thickness direction extending between a pressure side and a suction side. The method includes laying up a plurality of composite plies to form a residual airfoil portion. The plurality of composite plies includes at least one composite ply with fibers oriented along the spanwise direction. The method further includes laying up a plurality of composite plies to form a frangible airfoil portion. The plurality of composite plies forming the frangible airfoil portion have fibers that are oriented at least partially along the chordwise direction, the thickness direction, or both. Another step of the method includes processing the plurality of composite plies to form the frangible airfoil. It should be further understood that the method may further include any of the additional features as described herein.

These and other features, aspects and advantages will become better understood with reference to the following description and appended claims. The accompanying drawings, which are incorporated in and constitute a part of this specification, illustrate embodiments of the disclosure and, together with the description, serve to explain certain principles of the disclosure.

### BRIEF DESCRIPTION OF THE DRAWINGS

A full and enabling disclosure of the preferred embodiments, including the best mode thereof, directed to one of ordinary skill in the art, is set forth in the specification, which makes reference to the appended FIGS., in which:

FIG. 1 illustrates a cross-sectional view of one embodiment of a gas turbine engine that may be utilized within an aircraft in accordance with aspects of the present subject matter, particularly illustrating the gas turbine engine configured as a high-bypass turbofan jet engine;

FIG. 2 illustrates a cross-sectional view of the fan section of FIG. 1 in accordance with aspects of the present subject matter, particularly illustrating a fan blade of the fan section;

FIG. 3 illustrates a fan blade of the fan section of FIGS. 1 and 2 in accordance with aspects of the present subject matter, particularly illustrating a frangible airfoil portion and a residual airfoil portion;

FIG. 4 illustrates one embodiment of a layup orientation of an airfoil in accordance with aspects of the present subject matter;

FIG. 5 illustrates a frangible airfoil portion accordance with aspects of the present subject matter, particularly illustrating the frangible layup orientation;

FIG. 6 illustrates one embodiment of the residual airfoil portion in accordance with aspects of the present subject matter, particularly illustrating a residual layup orientation of the residual airfoil portion;

FIG. 7 illustrates a cross-section of the airfoil in accordance with aspects of the present subject matter, particularly illustrating a frangible line between the frangible airfoil portion and the residual airfoil portion; and

FIG. 8 depicts a method of forming a frangible airfoil in accordance with aspects of the present subject matter.

Repeat use of reference characters in the present specification and drawings is intended to represent the same or analogous features or elements of the present disclosure.

### DETAILED DESCRIPTION

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

As used herein, the terms “first”, “second”, and “third” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The terms “communicate,” “communicating,” “communicative,” and the like refer to both direct communication as well as indirect communication such as through a memory system or another intermediary system.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin. These approximating margins may apply to a single value, either or both endpoints defining numerical ranges, and/or the margin for ranges between endpoints.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

A frangible airfoil for gas turbine engines is generally provided. The airfoil may define a frangible line separating a frangible airfoil portion and a residual airfoil portion. The residual airfoil portion may extend between the frangible line and an airfoil root along a span. Further, the airfoil may define the frangible airfoil portion extending between the frangible line and the tip along the span. The frangible airfoil portion positioned radially outward from the frangible line may include a reduced bending stiffness such that the frangible airfoil portion may break-off or bend during a failure mode of the airfoil. More particularly, the residual airfoil portion may include at least one composite ply with fibers oriented along a spanwise direction to increase the bending stiffness along the span. The frangible airfoil portion may include composite plies having fibers oriented at least partially along a chordwise direction of the airfoil, a thickness direction of the airfoil, or both, such that the frangible airfoil defines a reduced bending stiffness along the span. The embodiments generally shown and described herein may enable a controlled and consistent failure of the airfoil, such as a fan blade, following a failure event, such as a hard rub against a surrounding fan case. The embodiments generally described herein enable the airfoil to deform or detach at a desired span of the airfoil to mitigate load transfer to a surrounding casing. The embodiments generally provided herein may further enable the airfoil to deform or detach such that excessive or extreme unbalance of the fan rotor may be reduced following a failure event, such as airfoil liberation, foreign object damage (e.g., bird strikes, icing, etc.), or loss of lube or damper to a bearing assembly.

Advantageously, by incorporating smaller modulus fibers and/or a lower modulus resin in the frangible airfoil portion, the overall damping effects of the engine during a fan blade out (FBO) event can be modified. For example, utilizing the smaller modulus fibers and/or lower modulus resin allows for failure of the airfoil such that overall loads for the engine are reduced during a FBO event. Accordingly, modification of the modulus values for the fibers and resins utilized in the frangible airfoil portion can tune the damping and can result in an advantage for the overall system load on the engine and can facilitate reducing the overall weight of the engine.

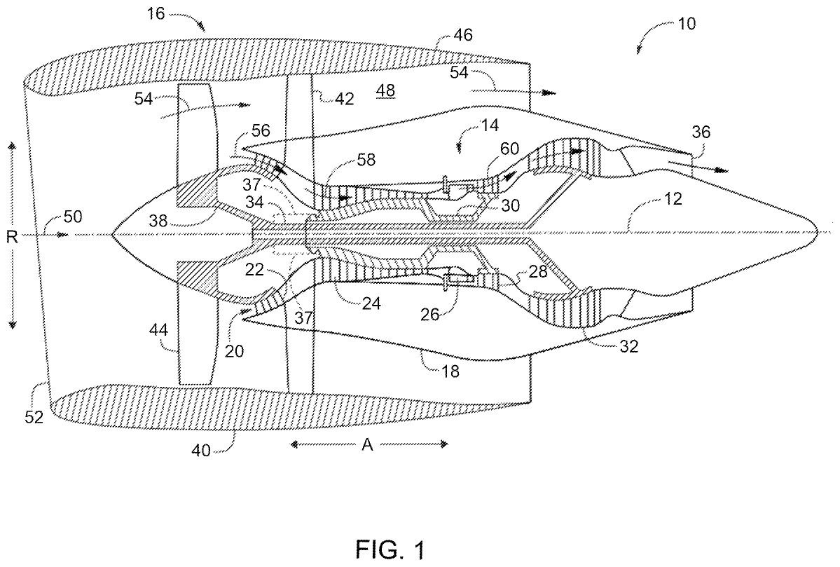

Referring now to the drawings, FIG. 1 illustrates a cross-sectional view of one embodiment of a gas turbine engine 10 that may be utilized within an aircraft in accordance with aspects of the present subject matter. More particularly, for the embodiment of FIG. 1, the gas turbine engine is a high-bypass turbofan jet engine, with the gas turbine engine 10 being shown having a longitudinal or axial centerline axis 12 extending therethrough along an axial direction A for reference purposes. The gas turbine engine 10 further defines a radial direction R extended from the centerline 12. Although an exemplary turbofan embodiment is shown, it is anticipated that the present disclosure can be equally applicable to turbomachinery in general, such as an open rotor turbofan engine (e.g., a turbofan without an outer nacelle), a turboshaft, turbojet, or a turboprop configuration, including marine and industrial turbine engines and auxiliary power units.

In general, the gas turbine engine 10 includes a turbomachine 14 and a fan section 16 positioned upstream thereof. The turbomachine 14 generally includes a substantially tubular outer casing 18 that defines an annular inlet 20. In addition, the outer casing 18 may further enclose and support a low pressure (LP) compressor 22 for increasing the pressure of the air that enters the turbomachine 14 to a first pressure level. A multi-stage, axial-flow high pressure (HP) compressor 24 may then receive the pressurized air from the LP compressor 22 and further increase the pressure of such air. The pressurized air exiting the HP compressor 24 may then flow to a combustor 26 within which fuel is injected into the flow of pressurized air, with the resulting mixture being combusted within the combustor 26. The high energy combustion products are directed from the combustor 26 along the hot gas path of the gas turbine engine 10 to a high pressure (HP) turbine 28 for driving the HP compressor 24 via a high pressure (HP) shaft 30 or spool, and then to a low pressure (LP) turbine 32 for driving the LP compressor 22 and fan section 16 via a low pressure (LP) shaft 34 or spool that is generally coaxial with HP shaft 30. After driving each of turbines 28 and 32, the combustion products may be expelled from the turbomachine 14 via an exhaust nozzle 36 to provide propulsive jet thrust.

Additionally, the fan section 16 of the gas turbine engine 10 generally includes a rotatable, axial-flow fan rotor 38 configured to be surrounded by an annular fan casing 40. In particular embodiments, the LP shaft 34 may be connected directly to the fan rotor 38, such as in a direct-drive configuration. In alternative configurations, the LP shaft 34 may be connected to the fan rotor 38 via a speed reduction device 37 such as a reduction gear gearbox in an indirect-drive or geared-drive configuration. Such speed reduction devices may be included between any suitable shafts/spools within the gas turbine engine 10 as desired or required.

It should be appreciated by those of ordinary skill in the art that the fan casing 40 may be configured to be supported relative to the turbomachine 14 by a plurality of substantially radially-extending, circumferentially-spaced outlet guide vanes 42. As such, the fan casing 40 may enclose the fan rotor 38 and its corresponding fan rotor blades (fan blades 44). Moreover, a downstream section 46 of the fan casing 40 may extend over an outer portion of the turbomachine 14 so as to define a secondary, or by-pass, airflow conduit 48 that provides additional propulsive jet thrust.

During operation of the gas turbine engine 10, it should be appreciated that an initial airflow (indicated by arrow 50) may enter the gas turbine engine 10 through an associated inlet 52 of the fan casing 40. The air flow 50 then passes through the fan blades 44 and splits into a first compressed air flow (indicated by arrow 54) that moves through the by-pass conduit 48 and a second compressed air flow (indicated by arrow 56) which enters the LP compressor 22. The pressure of the second compressed air flow 56 is then increased and enters the HP compressor 24 (as indicated by arrow 58). After mixing with fuel and being combusted within the combustor 26, the combustion products 60 exit the combustor 26 and flow through the HP turbine 28. Thereafter, the combustion products 60 flow through the LP turbine 32 and exit the exhaust nozzle 36 to provide thrust for the gas turbine engine 10.

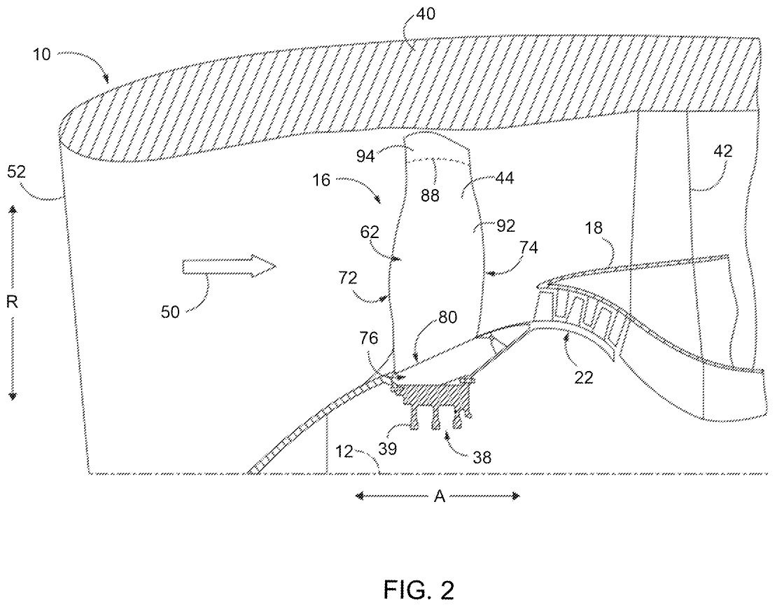

Referring to FIG. 2, exemplary airfoil 62 embodiments are provided in the context of a fan blade 44 positioned in fan section 16. Although the illustrated airfoils 62 are shown as part of a fan blade 44, it is understood that the following discussion of an airfoil 62 may be equally applied to another airfoil embodiment, e.g., a stator vane or rotor blade of a compressor 22, 24 and/or turbine 28, 32 (see FIG. 1). The outer casing 18, LP compressor 22, and outlet guide vanes 42 are also shown. As noted, during operation of the gas turbine engine 10, an initial airflow (indicated by arrow 50) enters the gas turbine engine 10 through an associated inlet 52 of the fan casing 40. The air flow 50 then passes through the fan blades 44. Optionally, each fan blade 44 includes an integral component having an axial dovetail 76 leading to a transition section 80. When mounted within the gas turbine engine 10 the axial dovetail 76 is disposed in a dovetail slot of the fan rotor disk 39, thereby attaching the fan blades 44 to the fan rotor 38. Each fan blade 44 extends radially outwardly from an airfoil root 64 to an airfoil tip 66. The airfoil includes a residual airfoil portion 92 and a frangible airfoil portion 94 that meet at the frangible line 88. The residual airfoil portion 92 and frangible airfoil portion 94 each extending between the airfoil's leading edge 72 to trailing edge 74 between the airfoil root 64 and airfoil tip 66. The frangible airfoil portion 94 includes one or more composite plies having fibers including a first fiber modulus as will be discussed further hereinbelow.

During operation of the gas turbine engine 10, such as following an event generating substantial imbalance in the fan rotor 38 or LP shaft 34, the frangible airfoil portion 94, e.g., of the fan blade 44 may be configured to deform or partially detach from the remainder of the airfoil 62, e.g., along or radially outward from the frangible line 88. Events generating substantial unbalance in the fan rotor 38 and/or LP shaft 34 may include, but are not limited to, foreign object damage (e.g., bird strikes, ice ingestion, other debris, etc.) or fan blade 44 detachment. Deformation of the frangible airfoil potion 94 may reduce undesired unbalance or vibrations as the fan rotor 38 and/or LP shaft 34 continue to rotate. Further, delamination of the frangible airfoil portion 94 can occur during light rub conditions, e.g. cross wind, or under medium rub conditions, e.g. bird impact. Inclusion of the composite plies having a first fiber modulus described herein, can help prevent material loss of the tip 66 during certain conditions that can achieve controlled fan rubs. Furthermore, the embodiments of the airfoil 62 may enable a lighter outer casing 18 or nacelle, such as reducing an amount of metal materials or abradable material of the fan casing 40 or nacelle.

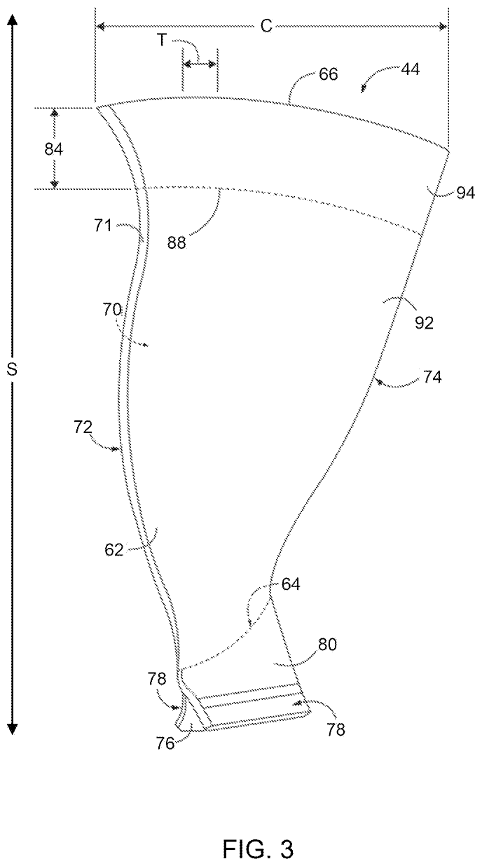

Referring now to FIG. 3, an exemplary airfoil 62 for a fan blade 44 is shown. Optionally, each fan blade 44 includes an integral component having an axial dovetail 76 with a pair of opposed pressure faces 78 leading to a transition section 80. The fan blade 44 extends radially outwardly along a span defining a spanwise direction S from an airfoil root 64 to an airfoil tip 66. A pressure side 68 and a suction side 70 of the airfoil 62 extend from the airfoil's leading edge 72 to a trailing edge 74 and between the airfoil root 64 and airfoil tip 66 along the span. Further, it should be recognized that airfoil 62 may define a chordwise direction C along a chord at each point along the span and extending between the leading edge 72 and the trailing edge 74. Further, the chord may vary along the span of the airfoil 62. For instance, in the depicted embodiment, the chord increases along the span toward the airfoil tip 66. Though, in other embodiments, the chord may be approximately constant throughout the span or may decrease from the airfoil root 64 to the airfoil tip 66.

The airfoil 62 may define a thickness direction T along a thickness extending between the pressure side 68 and the suction side 70 at each point along the span. In certain embodiments, the thickness may be approximately constant throughout the span of the airfoil 62. In other embodiments, the airfoil 62 may define a variable thickness between the airfoil root 64 and the airfoil tip 66. For instance, the thickness may generally decrease along the span toward the airfoil tip 66. Additionally, the airfoil 62 may define an approximately constant thickness along the chord at each point along the span. Or, in other embodiments, at least one point along the span of the airfoil 62 may define a variable thickness along the chord. For instance, the airfoil 62 may define a maximum thickness at a position along the chord at each point along the span.

Further, the airfoil 62 may define a frangible line 88 separating a frangible airfoil portion 94 and a residual airfoil portion 92. The frangible airfoil portion 94 may generally be positioned toward the airfoil tip 66 and extend between the leading edge 72 and trailing edge 74 and between the airfoil tip 66 and the frangible line 88. The residual portion may extend from the frangible line 88 to the airfoil root 64 along the spanwise direction S. Optionally, a metallic leading edge shield 71 may cover an axially extending portion of the airfoil 62 including at least a portion of the leading edge 72. In other embodiments, the metallic leading edge shield 71 may also cover portions of the tip 66 and the trailing edge 74 (not shown in FIG. 3).

As further illustrated in FIG. 3, the frangible line 88 may generally extend along the chordwise direction C between the leading edge 72 and the trailing edge 74. It should be recognized that the frangible line 88 may generally extend along the chordwise direction C at approximately the same point along the span. In other embodiments, the frangible line 88 may at least partially extend radially inward or outward (e.g., along the spanwise direction S) as the frangible line 88 extends axially along the chordwise direction C toward the trailing edge 74. For instance, in certain embodiments, the frangible line 88 may be defined along the chordwise direction C at one point along the span. In other embodiments, the frangible line 88 may extend along a variable percentage of the span from the leading edge 72 to the trailing edge 74. In one embodiment, the frangible airfoil portion 94 may extend along at least 10% of the span from the airfoil tip 66, such as along a chordwise direction C at one point along spanwise. More particularly, as illustrated, the frangible airfoil portion 94 may define a frangible height 84 extending between the airfoil tip 66 and the frangible line 88. As such, the frangible height 84 may extend along at least ten percent of the span between the leading edge 72 and the trailing edge 74. In another embodiment, the frangible airfoil portion 94 and/or the frangible height 84 may extend along at least 15% but less than 50% of the span between the leading edge 72 and the trailing edge 74. The frangible airfoil portion 94 may have a reduced overall bending stiffness compared to the residual airfoil portion 92.

Referring particularly to the exemplary airfoil 62 of FIG. 3, the airfoil 62 may be configured to fracture, break, or liberate at approximately the frangible line 88 up to the airfoil tip 66 (e.g., the frangible airfoil portion 94) following a loading or impact upon the airfoil 62. For example, the airfoil 62 configured as the fan blade 44 within the fan casing 40 or nacelle of the gas turbine engine 10 (FIG. 1) may be configured to detach, decouple, deform, break, or liberate the frangible airfoil portion 94 of the airfoil 62 at or radially outward from the frangible line 88. In one non-limiting example, the frangible airfoil portion 94 of the airfoil 62 may be defined as the difference in spanwise dimensions of the frangible airfoil portion 94 and the residual airfoil portion 92. For example, the frangible airfoil portion 94 may be defined within approximately 3% to approximately 15% (e.g., the frangible height 84) of the total span from the airfoil tip 66.

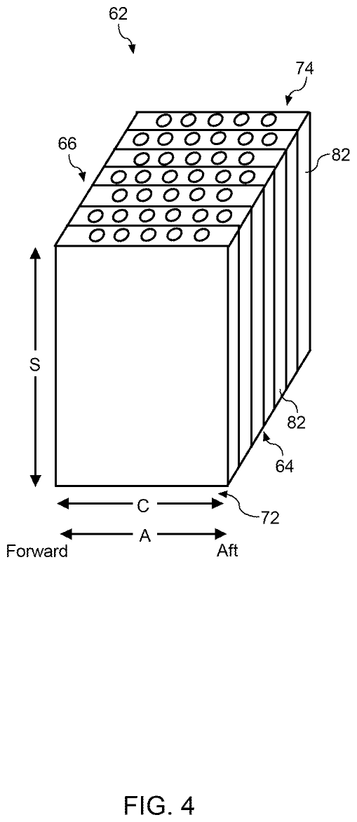

Referring to FIG. 4, the airfoil 62 may include a plurality of composite plies 82 extending from the leading edge 72 to the trailing edge 74 and between the airfoil tip 66 and the airfoil root 64. For instance, one or more composite plies 82 may extend from the airfoil tip 66 to the airfoil root 64. Or, in further embodiments, one or more composite plies 82 may be positioned in an end-to-end arrangement. For instance, two composite plies 82 may be arranged end-to-end to extend along the spanwise direction S from the airfoil root 64 to the airfoil tip 66. Though, in further embodiments, more than two composite plies 82 may be arranged end-to-end to extend along the spanwise direction S, such as three or more composite plies 82.

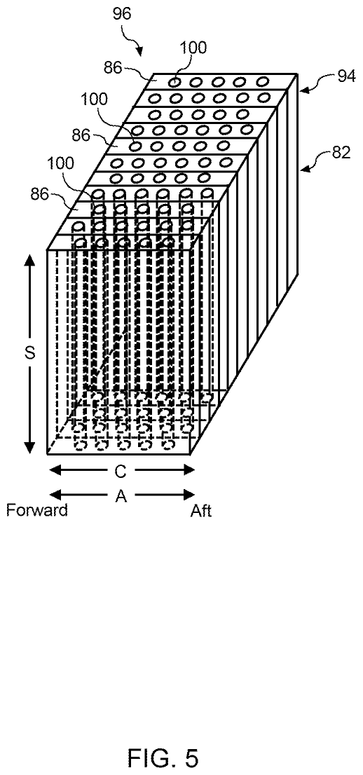

Referring now to FIG. 5, a frangible layup orientation 96 of the composite plies 82 for the frangible airfoil portion 94 is illustrated. The frangible airfoil portion 94 includes a first plurality of composite plies 86. Each of the first plurality of composite plies 86 includes fibers 100 having a first fiber modulus. The first fiber modulus includes a tensile modulus also referred to as Young's modulus. Fibers 100 include a first fiber modulus ranging from about 25 million pounds per square inch (Msi) to about 41 Msi, such as from about 32 Msi to about 35 Msi. While other composite plies 82 including fibers having a different fiber moduli from fibers 100 can be included, generally at least one or more of the composite plies 82, includes one or more of the first plurality of composite plies 86 having fibers 100 including the fiber modulus disclosed herein. For example, in certain embodiments at least 40% to up to 100% of the composite plies 82 used to form the frangible airfoil portion 94 are formed from a first plurality of composite plies 86 including fibers 100. The fibers 100 can be oriented along the chordwise direction C, the thickness direction T, or the spanwise direction S, or combinations thereof. For example, in embodiments at least 50%, such as at least 75% of the fibers 100 present in the first plurality of composite plies 86 are oriented in the chordwise direction C. In other embodiments, at least 50%, such as at least 75% of the fibers 100 present in the first plurality of composite plies 86 are oriented in the thickness direction T. Still, in other embodiments, at least 50%, such as at least 75% of the fibers 100 present in the first plurality of composite plies 86 are oriented in the spanwise direction S.

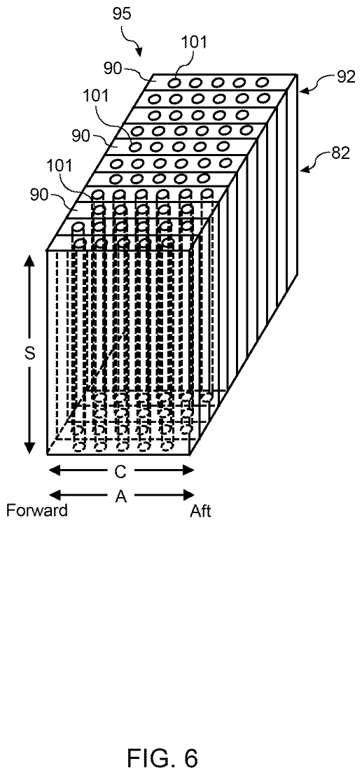

Referring now to FIG. 6, a residual layup orientation 95 of the composite plies 82 for the residual airfoil portion 92 is illustrated. The frangible airfoil portion 94 includes a second plurality of composite plies 90. Each of the second plurality of composite plies 90 includes fibers 101 having fiber modulus, such as a second fiber modulus that is different from the first fiber modulus of fibers 100 (shown in the frangible layup orientation 96 of FIG. 5). The second fiber modulus includes a tensile modulus also referred to as Young's modulus. Fibers 101 include a fiber modulus ranging from about 34 Msi to about 56 Msi, such as from about 42 Msi to about 47 Msi. While other composite plies 82 including fibers having a different moduli from fibers 101 can be included, generally at least one or more of the composite plies 82, includes one or more of the first plurality of composite plies 86 having fibers 101 including the second fiber modulus disclosed herein. For example, in certain embodiments at least 40% to up to 100% of the composite plies 82 used to form the residual airfoil portion 94 are formed from a second plurality of composite plies 90 including fibers 101. The fibers 101 can be oriented along the chordwise direction C, the thickness direction T, or the spanwise direction S, or combinations thereof. For example, in embodiments at least 50%, such as at least 75% of the fibers 101 present in the second plurality of composite plies 90 are oriented in the chordwise direction C. In other embodiments, at least 50%, such as at least 75% of the fibers 101 present in the second plurality of composite plies 90 are oriented in the thickness direction T. Still, in other embodiments, at least 50%, such as at least 75% of the fibers 101 present in the second plurality of composite plies 90 are oriented in the spanwise direction S.

Indeed, the frangible airfoil portion 94 includes one or more composite plies 82, such as a first plurality of composite plies 86 that include fibers 100 having a first fiber modulus, while the residual airfoil portion 92 includes one or more composite plies, such as a second plurality of composite plies 90 that include fibers 101 having a second fiber modulus. The fibers 101 have a second fiber modulus that is greater than the fibers 100 having a first fiber modulus. Utilization of fibers having a smaller fiber modulus to form the frangible airfoil portion 94 as opposed to fibers having a greater or larger fiber modulus in the residual airfoil portion 92, allows for the frangible airfoil portion 94 to deform, delaminate, partially detach, or fully detach at or above the frangible line 88 during certain events creating imbalance.

It should be appreciated, that while a first plurality of composite plies 86 having fibers 100 are used in the frangible airfoil portion 94 and a second plurality of composite plies 90 having fibers 101, including a greater fiber modulus as compared to fibers 100, are used in the airfoil described herein, additional composite plies 82 can be incorporated into either the residual airfoil portion 92 and/or the frangible airfoil portion 94 as desired. For example, additional composite plies 82 including fibers having different fiber moduli as compared to fibers 100 and 101 can be included in either the residual airfoil portion 92 and/or the frangible airfoil portion 94. Furthermore, it is contemplated that in addition to composite plies 86 and 90, one or more composite plies 82 can extend the entire span from the airfoil root 64 to the airfoil tip 66 (not shown in the figures).

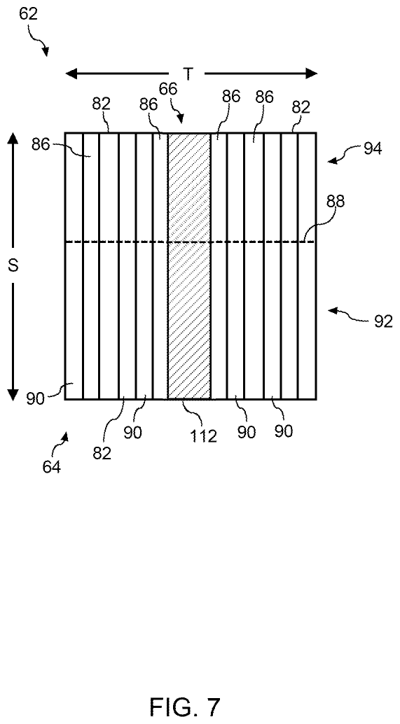

Referring now to FIG. 7 a cross-section of the airfoil 62 is illustrated in accordance with aspects of the present disclosure. Particularly, FIG. 7 illustrates the frangible line 88 between the frangible airfoil portion 94 and the residual airfoil portion 92. The plurality of composite plies 82 (including the first plurality of composite plies 86 and the second plurality of composite plies 90) are bonded together as laminate stacks on an airfoil core 112. The stacks generally extend outward across the thickness direction T. The airfoil core 112 may form the base guide for laying up the composite plies 82. Although the airfoil core 112 is shown as a solid body for the sake of clarity, optional embodiments of the airfoil core 112 may be configured as additional plies parallel to one or more of the composite plies 82. For instance, in optional embodiments, the airfoil core 112 may include multiple composite plies 82 that are each continuous in a spanwise S direction. For example, some continuous plies may extend uninterrupted or unbroken from the airfoil root 64 to the airfoil tip 66. Further additional or alternative embodiments of the airfoil core 112 may define a hollow cavity extending partially or fully from the airfoil root 64 to the airfoil tip 66. Optionally, a stiffening material may be placed within or fill the hollow cavity. For instance, a woven core, a foam, or a suitable low density material may substantially fill a hollow cavity of the airfoil core 112.

As shown, the airfoil 62 includes one or more of a first plurality of plies 86 having fibers 100 (not shown) included in the frangible airfoil portion 94, while one or more of a second plurality of plies 90 having fibers 101 (not shown) are included in the residual portion 92 of the airfoil 62. As previously described, fibers 101 included in the second plurality of plies 90 have a greater fiber modulus as compared to fibers 100, which are included in the first plurality of plies 86. The residual airfoil portion 92, including the second plurality of composite plies 90 having fibers 101 that include a greater fiber modulus is less brittle as compared to the frangible airfoil portion 94, which contains the first plurality of composite plies 86 having fibers 100 with a smaller fiber modulus.

It should be recognized that composite plies 82, including both the first and second plurality of composite plies 86, 90 may be joined together using any means. For example, the composite plies 82 may be arranged end-to-end and fixed during a process to finish forming the composite component. In other embodiments, the composite plies 82 may be adhered or coupled together. Further, in one embodiment, composite plies may be joined together using one or more overlap joints. In certain embodiments, one or more butt joints may be used to join the composite plies 82 together.

In certain embodiments, the first plurality of composite plies including fibers 100 having a first fiber modulus may define a portion of the airfoil 62 with a first overall bending stiffness. Similarly, the residual airfoil portion 92 may define a portion of the airfoil 62 with a second overall bending stiffness. The first overall bending stiffness of the frangible airfoil portion 94 may be less than the second overall bending stiffness of the residual airfoil portion 92. In certain embodiments, use of fibers 100 having a smaller fiber modulus as compared to fibers 101 having a larger fiber modulus, decreases the first overall bending stiffness of the frangible airfoil portion 94 relative to the residual airfoil portion 92. Furthermore, the composite plies, including the first plurality of plies 86 and/or the second plurality of plies 90, can be oriented to provide increased or decreased bending stiffness in certain directions for either the frangible airfoil portion 94 and/or of the residual airfoil portion. For example, generally, composite plies 82 define an increased bending stiffness in the direction the fibers 100, 101 are oriented. As such, orienting the first plurality of composite plies 86 in the spanwise direction S, can decrease overall bending stiffness along the spanwise direction S. The same is true for the chordwise direction C and thickness direction T. Accordingly, in order to achieve the desired decrease in bending stiffness for the frangible airfoil portion 94, plies 86 including fibers 100 can be incorporated in the spanwise direction S, the chordwise direction C, and/or the thickness direction T, in order to achieve the desired bending stiffness for each direction of the frangible airfoil portion 94. Similarly, the second plurality of composite plies 90 can be included and oriented in the chordwise direction C, the spanwise direction S, and the thickness direction T, to achieve the desired bending stiffness for the residual airfoil portion 92 in each direction. Thus, the second plurality of plies 90 can be oriented in a number of configurations in order to provide a residual airfoil portion 92 having increased bending stiffness in the spanwise direction S, the chordwise direction C, and/or the thickness direction T, as compared to the frangible airfoil portion 94.

As discussed, the airfoil 62, the frangible airfoil portion 94, and/or residual airfoil portion 92 may include at least one composite ply 82, including plies from a first plurality of composite plies 86 and a second plurality of composite plies 90. The described plies can be incorporated into an airfoil 62 that is formed, at least partially, from a ceramic matrix composite. More particularly, in certain embodiments, the airfoil 62 may be formed from one or more composite plies 82 configured as ceramic matrix composite prepreg plies.

Composite materials may include, but are not limited to, metal matrix composites (MMCs), polymer matrix composites (PMCs), or ceramic matrix composites (CMCs). Composite materials, such as may be utilized in the airfoil 62, generally comprise a fibrous reinforcement material embedded in matrix material, such as polymer, ceramic, or metal material. The reinforcement material serves as a load-bearing constituent of the composite material, while the matrix of a composite material serves to bind the fibers together and act as the medium by which an externally applied stress is transmitted and distributed to the fibers.

Exemplary CMC materials may include silicon carbide (SiC), silicon, silica, or alumina matrix materials and combinations thereof. Ceramic fibers may be embedded within the matrix, such as oxidation stable reinforcing fibers including monofilaments like sapphire and silicon carbide (e.g., Textron's SCS-6), as well as rovings and yarn including silicon carbide (e.g., Nippon Carbon's NICALON®, Ube Industries' TYRANNO®, and Dow Corning's SYLRAMIC®), alumina silicates (e.g., Nextel's 440 and 480), and chopped whiskers and fibers (e.g., Nextel's 440 and SAFFIL®), and optionally ceramic particles (e.g., oxides of Si, Al, Zr, Y, and combinations thereof) and inorganic fillers (e.g., pyrophyllite, wollastonite, mica, talc, kyanite, and montmorillonite). For example, in certain embodiments, bundles of the fibers, which may include a ceramic refractory material coating, are formed as a reinforced tape, such as a unidirectional reinforced tape. A plurality of the tapes may be laid up together (e.g., as the composite plies 82) to form a preform component. The bundles of fibers may be impregnated with a slurry composition prior to forming the preform or after formation of the preform. The preform may then undergo thermal processing, such as a cure or burn-out to yield a high char residue in the preform, and subsequent chemical processing, such as melt-infiltration with silicon, to arrive at a component formed of a CMC material having a desired chemical composition.

Similarly, in various embodiments, PMC materials may be fabricated by impregnating a fabric or unidirectional tape with a resin (prepreg), followed by curing. For example, multiple layers of prepreg plies (e.g., the composite plies 82) may be stacked to the proper thickness and orientation for the part, and then the resin may be cured and solidified to render a fiber reinforced composite part. As another example, a die may be utilized to which the uncured layers of prepreg may be stacked to form at least a portion of the composite component. The die may be either a closed configuration (e.g., compression molding) or an open configuration that utilizes vacuum bag forming. For instance, in the open configuration, the die forms one side of the blade (e.g., the pressure side 68 or the suction side 70). The PMC material is placed inside of a bag and a vacuum is utilized to hold the PMC material against the die during curing. In still other embodiments, the airfoil 62 may be at least partially formed via resin transfer molding (RTM), light resin transfer molding (LRTM), vacuum assisted resin transfer molding (VARTM), a forming process (e.g. thermoforming), or similar.

Prior to impregnation, the fabric may be referred to as a “dry” fabric and typically comprises a stack of two or more fiber layers. The fiber layers may be formed of a variety of materials, non-limiting examples of which include carbon (e.g., graphite), glass (e.g., fiberglass), polymer (e.g., Kevlar®) fibers, and metal fibers. Fibrous reinforcement materials can be used in the form of relatively short chopped fibers, generally less than two inches in length, and more preferably less than one inch, or long continuous fibers, the latter of which are often used to produce a woven fabric or unidirectional tape. Other embodiments may include other textile forms such as plane weave, twill, or satin.

In one embodiment, PMC materials can be produced by dispersing dry fibers into a mold, and then flowing matrix material around the reinforcement fibers. Resins for PMC matrix materials can be generally classified as thermosets or thermoplastics. Thermoplastic resins are generally categorized as polymers that can be repeatedly softened and flowed when heated and hardened when sufficiently cooled due to physical rather than chemical changes. Notable example classes of thermoplastic resins include nylons, thermoplastic polyesters, polyaryletherketones, and polycarbonate resins. Specific examples of high performance thermoplastic resins that have been contemplated for use in aerospace applications include polyetheretherketone (PEEK), polyetherketoneketone (PEKK), polyetherimide (PEI), and polyphenylene sulfide (PPS). In contrast, once fully cured into a hard rigid solid, thermoset resins do not undergo significant softening when heated but, instead, thermally decompose when sufficiently heated. Notable examples of thermoset resins include epoxy, bismaleimide (BMI), and polyimide resins.

Furthermore, in certain embodiments, the airfoils disclosed herein can include a first resin in the frangible airfoil portion 94 and a second resin in the residual airfoil portion 92. Indeed, the first resin can have a lower modulus of elasticity as compared to the second resin.

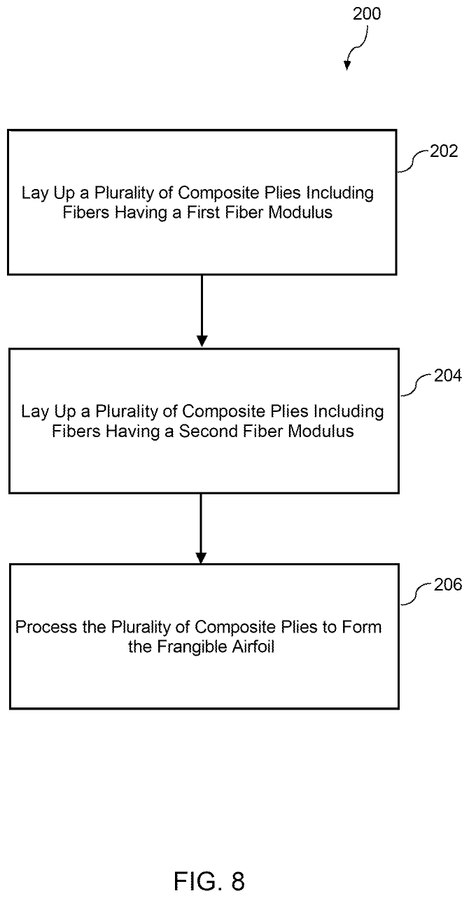

Referring now to FIG. 8, a method 200 of forming a frangible airfoil is depicted according to aspects of the present subject matter. Particularly, the method 200 may be used to form various embodiments of the airfoil 62 as illustrated in FIGS. 3-7. For, instance, the frangible airfoil may define a span extending in a spanwise direction S between a root and a tip, a chordwise direction C extending between a leading edge and a trailing edge, and a thickness direction T extending between a pressure side and a suction side.

The method 200 may include 202 laying up a plurality of composite plies to form a frangible airfoil portion. The plurality of composite plies forming the frangible airfoil portion have fibers having a first fiber modulus. The plies can be oriented along the chordwise direction C, the thickness direction T, the span direction S, or combinations thereof. In embodiments, at least 50%, such as at least 75% of the plies can be oriented in the chordwise direction C, the thickness direction T, the span direction S, or a combination thereof. For example, in embodiments at least 50% of the plies are oriented in the chordwise direction C, the thickness direction T, or both. Further, the plurality of composite plies forming the frangible airfoil portion may be the first plurality of composite plies. More particularly, each of the first plurality of composite plies may include fibers having a first fiber modulus. At, 204 the method includes laying up a plurality of composite plies to form a residual airfoil portion. In such an embodiment, the plurality of composite plies may include at least one composite ply having fibers having a second fiber modulus. Particularly, the first fiber modulus is different from the second fiber modulus. Indeed, in embodiments, the second fiber modulus is greater than the first fiber modulus of the fibers used to form one or more plies in the frangible airfoil portion. The plurality of composite plies may include a composite material such as a CMC material. The composite plies may be laid up on a tool, mandrel, mold, or other suitable supporting device or surface.

In a further embodiment of the method 200, at least one of the composite plies used to form either the frangible airfoil portion or the residual airfoil portion may be a prepreg ply. For example, at least a portion (e.g., the first and/or second plurality of composite plies 86, 90) of the composite plies used to form the composite frangible airfoil may be prepreg plies. In one particular embodiment, all of the composite plies may be prepreg plies. In a further embodiment, at least one of the composite plies may a ceramic matrix composite ply, such as all of the composite plies. In certain embodiments, at least one of the composite plies 82 may be a ceramic matrix composite prepreg ply.

Another step of the method 200 may include 206 processing the plurality of plies to form the frangible airfoil. In one embodiment, processing the composite plies may include compacting the composite plies. In another embodiment of the method 200, processing the composite plies may include autoclaving the composite plies. In a still further embodiment of the method 200, processing the composite plies may include both compacting and autoclaving the composite plies. For instance, the composite plies may be compacted and then processed in an autoclave. The compaction may be performed at atmosphere, i.e., at room temperature and pressure. The autoclave cycle may impart stiffness to the final ply and/or layup assembly through complete drying and/or curing of the composite constituents and produces the final dimensions of the composite component through full consolidation of the plies and/or sub-assemblies.

Further, in embodiments in which the composite plies are processed in an autoclave, the composite plies may be autoclaved using soft and/or hard tooling. For instance, the composite plies may be autoclaved using metallic tooling, i.e., hard tooling, that is shaped to impart a desired shape to the frangible airfoil. As another example, the composite plies may be autoclaved using soft tooling such as a vacuum bag, e.g., the composite plies may be supported on a metal tool and then the composite plies and tool may be bagged and the air removed from the bag to apply pressure to and compact the composite plies before the composite plies are processed in a autoclave cycle. For instance, processing composite plies may include autoclaving the composite plies to form an autoclaved body. Further, another step may include firing the autoclaved body to form a fired body. Processing the composite plies may further include densifying the fired body to form the composite component. In certain embodiments, processing the composite plies may include at least one of melt infiltration or polymer infiltration and pyrolysis.

In embodiments in which the composite material is a CMC material, the autoclaved body may undergo firing (or burn-off) to form a fired body, followed by densification to produce a densified CMC component that is a single piece component, i.e., the component is a continuous piece of CMC material. For instance, after autoclaving, the component may be placed in a furnace to burn off any mandrel-forming materials and/or solvents used in forming the CMC plies and to decompose binders in the solvents, and then placed in a furnace with silicon to convert a ceramic matrix precursor of the plies into the ceramic material of the matrix of the CMC component. The silicon melts and infiltrates any porosity created within the matrix as a result of the decomposition of the binder during burn-off/firing; the melt infiltration of the CMC component with silicon densifies the CMC component. However, densification may be performed using any known densification technique including, but not limited to, Silcomp, melt-infiltration (MI), chemical vapor infiltration (CVI), polymer infiltration and pyrolysis (PIP), and oxide/oxide processes. In one embodiment, densification and firing may be conducted in a vacuum furnace or an inert atmosphere having an established atmosphere at temperatures above 1200° C. to allow silicon or another appropriate material or materials to melt-infiltrate into the component.

Optionally, after processing, the composite component may be finish machined, if and as needed, and coated with one or more coatings, such as an environmental barrier coating (EBC). For example, the composite plies that are wrapped around the core may be oversized such that a portion of the composite plies extend beyond the desired trailing edge of the airfoil. Accordingly, after processing, the composite plies may be machined to define the trailing edge.

Of course, the method 200 described with respect to FIG. 8 is provided by way of example only. As such, other known methods or techniques for compacting and/or curing composite plies, as well as for densifying a CMC component, may be utilized. Alternatively, any combinations of these or other known processes may be used and in any suitable order. Further, although the method 200 of FIG. 8 is described relative to fan blades, the method 200 may also be used to form other composite components, such as turbine nozzle blades and turbine stator vanes and/or compressor blades and vanes including airfoils as exemplary composite components.

Further aspects of the disclosure are provided by the subject matter of the following clauses:

An airfoil defining a span extending in a spanwise direction between a root and a tip; a chordwise direction extending between a leading edge and a trailing edge; a thickness direction extending between a pressure side and a suction side; and a frangible line at a location along the span, the airfoil comprising: a frangible airfoil portion extending between the leading edge and the trailing edge and extending along the span between the tip and the frangible line, wherein the frangible airfoil portion comprises a first plurality of composite plies, one or more of the first plurality of composite plies having fibers defining a first fiber modulus; and a residual airfoil portion extending along the span from the frangible line to the root, the residual airfoil portion comprising a second plurality of composite plies having fibers defining a second fiber modulus, wherein the second fiber modulus is greater than the first fiber modulus, wherein the residual airfoil portion meets the frangible airfoil portion at the frangible line.

The airfoil of any preceding clause, wherein the frangible airfoil portion deforms or partially or fully detaches relative to the residual airfoil portion at the frangible line or radially outward from the frangible line following an event creating imbalance.

The airfoil of any preceding clause, wherein the frangible airfoil portion extends along at least 15% of the span from the tip.

The airfoil of any preceding clause, wherein the frangible airfoil portion extends along at least 15% but less than 50% of the span from the tip.

The airfoil of any preceding clause, wherein the first fiber modulus is from about 32 Msi to about 35 Msi.

The airfoil of any preceding clause, wherein the second fiber modulus is from about 42 Msi to about 47 Msi.

The airfoil of any preceding clause, wherein at least about 50% up to about 100% of the first plurality of composite plies comprise fibers defining a fiber modulus equal to the first fiber modulus.

The airfoil of any preceding clause, wherein the at least one of the first plurality of composite plies or the second plurality of composite plies comprise ceramic matrix composite plies.

The airfoil of any preceding clause, wherein the airfoil is a fan blade of a gas turbine engine.

The airfoil of any preceding clause, wherein at least 50% or more of the first plurality of composite plies are oriented in the chordwise direction, the thickness direction, or both.

The airfoil of any preceding clause, wherein the frangible airfoil portion comprises a first resin and the residual airfoil portion comprises a second resin, wherein the first resin has a lower modulus of elasticity as compared to the second resin.

A gas turbine engine defining a central axis, the gas turbine engine comprising: an engine shaft extending along the central axis; a compressor rotatable with the engine shaft; a combustor positioned downstream of the compressor to receive a compressed fluid therefrom; a turbine rotatable with the engine shaft at a location downstream of the combustor to provide a rotational force to the compressor; and a plurality of airfoils operably connected to the engine shaft, each of the plurality of airfoils defining a span extending in a spanwise direction between a root and a tip; a chordwise direction extending between a leading edge and a trailing edge; a thickness direction extending between a pressure side and a suction side; and a frangible line at a location along the span, the airfoil comprising: a frangible airfoil portion extending between the leading edge and the trailing edge and extending along the span between the tip and the frangible line, wherein the frangible airfoil portion comprises a first plurality of composite plies, one or more of the first plurality of composite plies having fibers defining a first fiber modulus; and a residual airfoil portion extending along the span from the frangible line to the root, the residual airfoil portion comprising a second plurality of composite plies having fibers defining a second fiber modulus, wherein the second fiber modulus is greater than the first fiber modulus, wherein the residual airfoil portion meets the frangible airfoil portion at the frangible line.

The gas turbine engine of any preceding clause, further comprising a fan section including the plurality of airfoils configured as fan blades.

The gas turbine engine of any preceding clause, wherein the frangible airfoil portion extends along at least 15% of the span from the tip.

The gas turbine engine of any preceding clause, wherein the frangible airfoil portion extends along at least 15% but less than 50% of the span from the tip.

The gas turbine engine of any preceding clause, wherein the first fiber modulus comprises from about 32 Msi to about 35 Msi.

The gas turbine engine of any preceding clause, wherein the second fiber modulus comprises from about 42 Msi to about 47 Msi.

The gas turbine engine of any preceding clause, wherein at least about 50% up to about 100% of the first plurality of composite plies comprise fibers having the first fiber modulus.

The gas turbine engine of any preceding clause, wherein the at least one of the first plurality of composite plies or the second plurality of composite plies comprise ceramic matrix composite plies.

A method of forming a frangible airfoil, the frangible airfoil defining a span extending in a spanwise direction between a root and a tip; a chordwise direction extending between a leading edge and a trailing edge; and a thickness direction extending between a pressure side and a suction side, the method comprising: laying up a first plurality of composite plies to form a frangible airfoil portion, wherein the first plurality of composite plies forming the frangible airfoil portion have fibers defining a first fiber modulus; laying up a second plurality of composite plies to form a residual airfoil portion, wherein the second plurality of composite plies forming the residual airfoil portion have fibers defining a second fiber modulus, wherein the second fiber modulus is greater than the first fiber modulus; and processing the first plurality of composite plies and second plurality of composite plies to form the frangible airfoil.

This written description uses exemplary embodiments to disclose the preferred embodiments, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. An airfoil defining a span extending in a spanwise direction between a root and a tip; a chordwise direction extending between a leading edge and a trailing edge; a thickness direction extending between a pressure side and a suction side; and a frangible line at a location along the span, the airfoil comprising:
a frangible airfoil portion extending between the leading edge and the trailing edge and extending along the span between the tip and the frangible line, wherein the frangible airfoil portion comprises a first plurality of composite plies, one or more of the first plurality of composite plies having fibers defining a first fiber modulus; and
a residual airfoil portion extending along the span from the frangible line to the root, the residual airfoil portion comprising a second plurality of composite plies having fibers defining a second fiber modulus, wherein the second fiber modulus is greater than the first fiber modulus, wherein the residual airfoil portion meets the frangible airfoil portion at the frangible line, wherein the frangible line extends from the leading edge to the trailing edge.

2. The airfoil of claim 1, wherein the frangible airfoil portion deforms or partially or fully detaches relative to the residual airfoil portion at the frangible line or radially outward from the frangible line following an event creating imbalance.

3. The airfoil of claim 1, wherein the frangible airfoil portion extends along at least 15% of the span from the tip.

4. The airfoil of claim 1, wherein the frangible airfoil portion extends along at least 15% but less than 50% of the span from the tip.

5. The airfoil of claim 1, wherein the first fiber modulus is from about 32 Msi to about 35 Msi.

6. The airfoil of claim 1, wherein the second fiber modulus is from about 42 Msi to about 47 Msi.

7. The airfoil of claim 1, wherein at least about 50% up to about 100% of the first plurality of composite plies comprise fibers defining a fiber modulus equal to the first fiber modulus.

8. The airfoil of claim 1, wherein the at least one of the first plurality of composite plies or the second plurality of composite plies comprise ceramic matrix composite plies.

9. The airfoil of claim 1, wherein the airfoil is a fan blade of a gas turbine engine.

10. The airfoil of claim 1, wherein at least 50% or more of the first plurality of composite plies are oriented in the chordwise direction, the thickness direction, or both.

11. The airfoil of claim 1, wherein the frangible airfoil portion comprises a first resin and the residual airfoil portion comprises a second resin, wherein the first resin has a lower modulus of elasticity as compared to the second resin.

12. A gas turbine engine defining an axial centerline axis, the gas turbine engine comprising:
an engine shaft extending along the axial centerline axis;
a compressor rotatable with the engine shaft;
a combustor positioned downstream of the compressor to receive a compressed fluid therefrom;
a turbine rotatable with the engine shaft at a location downstream of the combustor to provide a rotational force to the compressor; and
a plurality of airfoils operably connected to the engine shaft, each of the plurality of airfoils defining a span extending in a spanwise direction between a root and a tip; a chordwise direction extending between a leading edge and a trailing edge; a thickness direction extending between a pressure side and a suction side; and a frangible line at a location along the span, the airfoil comprising:
a frangible airfoil portion extending between the leading edge and the trailing edge and extending along the span between the tip and the frangible line, wherein the frangible airfoil portion comprises a first plurality of composite plies, one or more of the first plurality of composite plies having fibers defining a first fiber modulus; and
a residual airfoil portion extending along the span from the frangible line to the root, the residual airfoil portion comprising a second plurality of composite plies having fibers defining a second fiber modulus, wherein the second fiber modulus is greater than the first fiber modulus, wherein the residual airfoil portion meets the frangible airfoil portion at the frangible line, wherein the frangible line extends from the leading edge to the trailing edge.

13. The gas turbine engine of claim 12, further comprising a fan section including the plurality of airfoils configured as fan blades.

14. The gas turbine engine of claim 12, wherein the frangible airfoil portion extends along at least 15% of the span from the tip.

15. The gas turbine engine of claim 12, wherein the frangible airfoil portion extends along at least 15% but less than 50% of the span from the tip.

16. The gas turbine engine of claim 12, wherein the first fiber modulus comprises from about 32 Msi to about 35 Msi.

17. The gas turbine engine of claim 12, wherein the second fiber modulus comprises from about 42 Msi to about 47 Msi.

18. The gas turbine engine of claim 12, wherein at least about 50% up to about 100% of the first plurality of composite plies comprise fibers having the first fiber modulus.

19. The gas turbine engine of claim 12, wherein the at least one of the first plurality of composite plies or the second plurality of composite plies comprise ceramic matrix composite plies.

20. A method of forming a frangible airfoil, the frangible airfoil defining a span extending in a spanwise direction between a root and a tip; a chordwise direction extending between a leading edge and a trailing edge; and a thickness direction extending between a pressure side and a suction side, the method comprising:
laying up a first plurality of composite plies to form a frangible airfoil portion, wherein the first plurality of composite plies forming the frangible airfoil portion have fibers defining a first fiber modulus;
laying up a second plurality of composite plies to form a residual airfoil portion, wherein the second plurality of composite plies forming the residual airfoil portion have fibers defining a second fiber modulus, wherein the second fiber modulus is greater than the first fiber modulus and wherein a frangible line between the residual airfoil portion and the frangible airfoil portion extends from the leading edge to the trailing edge;
and
processing the first plurality of composite plies and second plurality of composite plies to form the frangible airfoil.
